(19) United States
(12) Patent Application Publication
(10) Pub. No.: US 2023/0237551 A1
(43) Pub. Date: Jul. 27, 2023

(54) AUTOBUY USING MACHINE LEARNING

(71) Applicant: Dell Products L.P., Round Rock, TX (US)

(72) Inventors: Mahuya Ghosh, Edison, NJ (US); Rajendra Kulkarni, Bangalore (IN)

(73) Assignee: Dell Products L.P., Round Rock, TX (US)

(21) Appl. No.: 17/648,709

(22) Filed: Jan. 24, 2022

(51) Int. Cl. G06Q 30/06; G06F 3/0482

(52) U.S. Cl. CPC G06Q 30/0627; G06Q 30/0643; G06Q 30/0631; G06F 3/0482

(57) ABSTRACT

A method for use in a hosting system of a retail website, comprising: receiving respective first values for a plurality of parameters of an auto-buy campaign, the respective first values being specified by an administrator of the retail website hosting system; calculating a configuration score for the auto-buy campaign based on the respective first values for the plurality of parameters of the auto-buy campaign, the configuration score being indicative of a percentage of auto-buy bids submitted as part of the auto-buy campaign that are expected to result in a purchase; and outputting an indication of the configuration score for presentation to the administrator.

### BACKGROUND

E-commerce involves the use of electronic means and technologies to conduct the sale, purchase of products. A typical e-commerce website will provide information about a product that is being offered and provide mechanisms for purchasing the product. A user may purchase the product by placing the product in the user's shopping cart and providing payment information for completing the purchase.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided for use in a hosting system of a retail website, comprising: receiving respective first values for a plurality of parameters of an auto-buy campaign, the respective first values being specified by an administrator of the retail website hosting system; calculating a configuration score for the auto-buy campaign based on the respective first values for the plurality of parameters of the auto-buy campaign, the configuration score being indicative of a percentage of auto-buy bids submitted as part of the auto-buy campaign that are expected to result in a purchase; and outputting an indication of the configuration score for presentation to the administrator.

According to aspects of the disclosure, a method is provided for use in a hosting system of a retail website, comprising: receiving respective first values for a plurality of parameters of a first auto-buy bid, the plurality of parameters of the first auto-buy bid including a product identifier corresponding to a first product and an indication of a first target price for the first product, the respective first values being specified by a user of the retail website; calculating a success score for the first auto-buy bid, the success score being indicative of a likelihood of the first product selling to the user at or below the first target price; and outputting an indication of the success score for presentation to the user.

According to aspects of the disclosure, a system is provided, comprising: a memory; and one or more processors operatively coupled to the memory, the one or more processors being configured to perform the operations of: receiving respective first values for a plurality of parameters of a first auto-buy bid, the plurality of parameters of the first auto-buy bid including a product identifier corresponding to a first product and an indication of a first target price for the first product, the respective first values being specified by a user of a retail website; calculating a success score for the first auto-buy bid, the success score being indicative of a likelihood of the first product selling to the user at or below the first target price; and outputting an indication of the success score for presentation to the user.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2A is a diagram of an example of a user interface screen, according to aspects of the disclosure;

FIG. 2B is a diagram of an example of a user interface screen, according to aspects of the disclosure;

FIG. 3 is a diagram of an example of a user interface screen, according to aspects of the disclosure;

FIG. 4A is a diagram of an example of a user interface screen, according to aspects of the disclosure;

FIG. 4B is a diagram of an example of a user interface screen, according to aspects of the disclosure;

FIG. 5 is a diagram of an example of a user interface screen, according to aspects of the disclosure;

FIG. 6 is a diagram of an example of an auto-buy management system, according to aspects of the disclosure;

FIG. 7 is a flowchart of an a process, according to aspects of the disclosure;

FIG. 8A is a flowchart of an example of a process, according to aspects of the disclosure;

FIG. 8B is a flowchart of an example of a process, according to aspects of the disclosure;

FIG. 9 is a flowchart of an example of a process, according to aspects of the disclosure;

and

FIG. 10 is a diagram of an example of a computing device, according to aspects of the disclosure.

### DETAILED DESCRIPTION

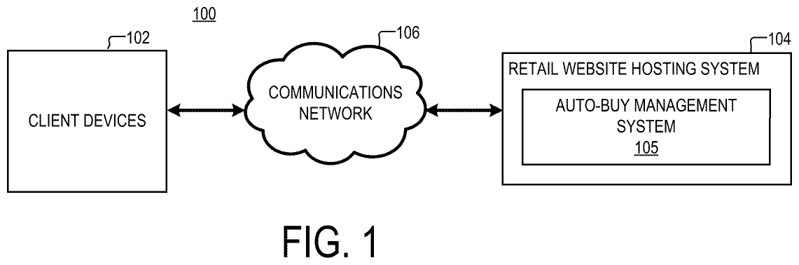

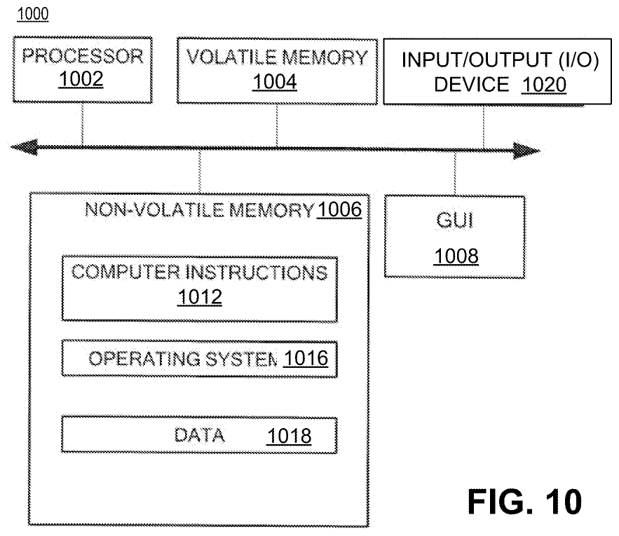

FIG. 1 is a diagram of an example of a system 100, according to aspects of the disclosure. As illustrated, the system 100 may include one or more client devices 102 that are coupled to a hosting system 104 via a communications network 106. Each of the client devices 102 may include a smartphone, a desktop computer, a laptop, and/or any other suitable type of computing device. In some implementations, each of the client devices 102 may be a computing device, such as the computing device 1000, which is discussed further below with respect to FIG. 10. The hosting system 104 may include one or more computing devices that are configured to host and/or manage a retail website. The hosting system 104 may include load balancers, frontend servers, backend servers, authentication servers, and/or any other suitable type of computing device. The hosting system 104 may include one or more computing devices, such as the computing device 1000, which is discussed further below with respect to FIG. 10. The communications network 106 may include one or more of a local area network (LAN), a wide area network (WAN), the Internet, a 5G cellular network, and/or any other suitable type of communications network.

The hosting system 104 may include an auto-buy provision system 105. The system 105 may be configured to provide an auto-buy feature to users of the retail website. The auto-buy feature, according to the present example, is a feature, which enables a user to specify a lower price than what a product is currently sold at, and which automatically purchases the product on behalf of the user should the product price fall to the level of the specified price. In addition, the auto-buy feature, according to the present example, enables administrators of the retail website to conduct an auto-buy campaign. An auto-buy campaign is an effort in which the auto-buy feature is enabled in a limited fashion. For example, in an auto-buy campaign, the auto-buy feature may be enabled for a limited period of time, for a specific product or product family, or only for customers who are located at a specific location and/or belong to a specific customer class.

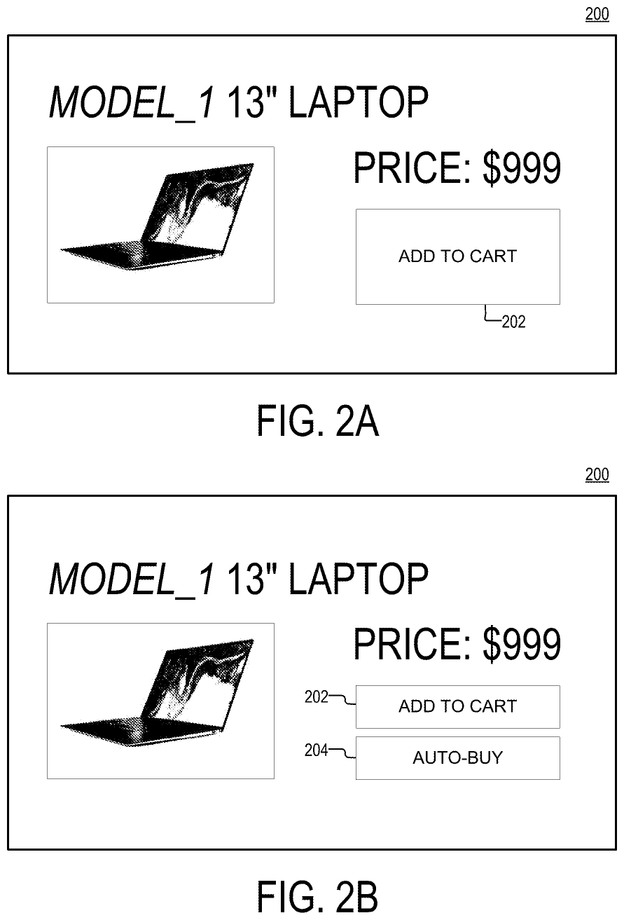

FIGS. 2A-B are schematic diagrams of an example of a web page 200 for a product sold on the retail website (i.e., the retail website that is hosted by the hosting system 104). The web page 200 can be transmitted by the hosting system 104 to a given one of the client devices 102. The web page 200 may be displayed on the given client device 102.

The web page 200 may include one or more of an image of a product, an indication of the price of the product, as well as any other information a user of the given client device 102 might find useful in making a purchase decision. The web page 200 may include an add-to-cart button 202, which allows the user to add the product to his or her shopping cart. When the auto-buy feature is enabled, the web page 200 may include an auto-buy button 204, which enables the user to place an auto-buy bid for a product (e.g., see FIG. 2B). The auto-buy button 204 may be hidden when the auto-buy feature is disabled (e.g., see FIG. 2A).

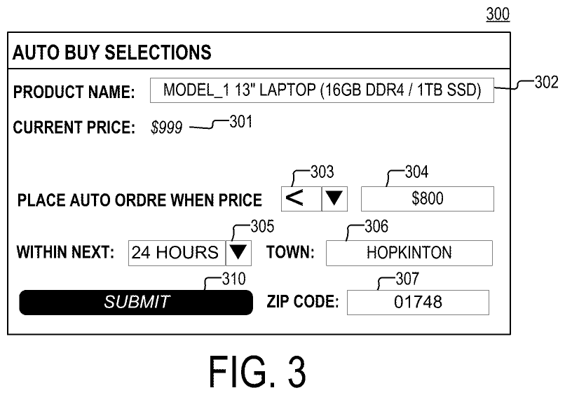

Pressing the auto-buy button 204 enables the user to place an auto-buy bid for the product shown in the web page 200. An auto-buy bid is an offer to buy a product at a price that is lower than the price at which the product is currently being offered. Consider an example in which the auto-buy feature is enabled. When the auto-buy button 204 is activated (e.g., pressed), the given client device 102 may transmit a message to the hosting system 104 indicating that the button 204 has been activated. In response to the message, the hosting system 104 may cause the given client device 102 to display a screen 300. Subsequently, the user may use the screen 300 to specify the values of various parameters of an auto-buy bid and provide the values to the hosting system 104 (and/or the system 105). An example of one possible implementation of the screen 300 is discussed further below with respect to FIG. 3.

FIG. 3 shows an example of a user interface screen 300 for placing an auto-buy bid for the product associated with the web page 200. The screen 300 may include a field 301, which specifies the current price of the product. The screen 300 may include input components 302-307 for specifying the values of various parameters of an auto-buy bid. Furthermore, the screen 300 may include a submit button 310, which when activated, causes the client device 102 (which is displaying the screen 300) to transmit the contents of input components 302-307 to the hosting system 104. According to the example of FIG. 3, input component 302 is configured to receive an identifier of a product which the user is willing to purchase (also referred to as the “target product” of the auto-buy bid). Input component 304 is configured to receive an indication of the price which the user is willing to pay for the product (also referred to as the target price of the auto-buy bid). Input component 306 is configured to receive a user input specifying a condition, which when fulfilled, would cause the auto-buy manager to purchase the product on behalf of the user. The condition, according to the present example, is associated with the target price that is being input with the input component 304. According to the present example, the condition specifies that the product should be purchased when the curent price of the product (including available discounts) falls below the target price. However, alternative implementations are possible in which the condition specifies that the product should be purchased when the current price of the product becomes equal to the target price. Input component 305 is configured to receive input specifying a duration for which the auto-buy bid will be open. Input components 306-307 are configured to receive user input specifying the shipping location for the auto-buy bid—i.e., the location where the target product would have to be delivered if it ends up being purchased.

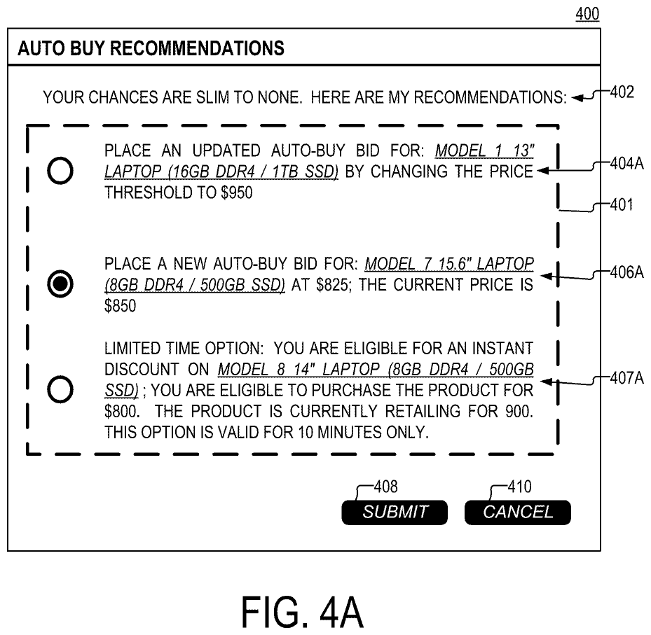

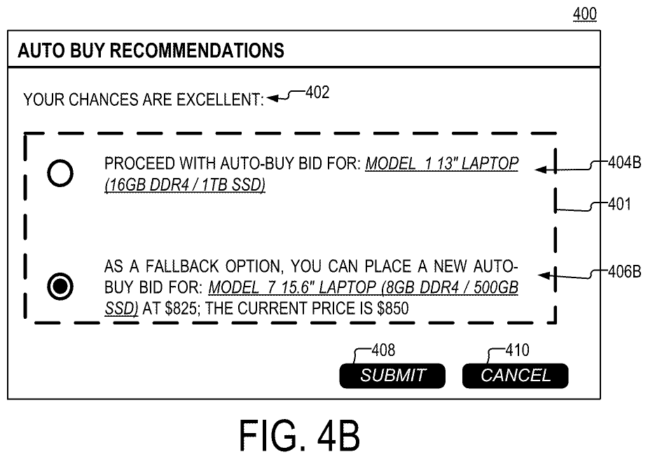

The user may use the screen 300 to input the values of various parameters for an original auto-buy bid. Afterwards, the user may press the submit button 310. In response to the submit button 310 being pressed, the client device 102 on which the screen 300 is displayed may forward the values of the parameters, which are input into the screen 300, to the system 105. In response to receiving the values, the system 105 may generate a confirmation screen 400, which is subsequently displayed on the given client device 102. Examples of contents that may be included in the screen 400 are provided further below with respect to FIGS. 4A-B.

FIG. 4A is a diagram of the screen 400, according to one example. In the example of FIG. 4A, the screen 400 indicates that the original auto-buy bid (that is specified via the screen 300) has a low likelihood of resulting in a purchase/sale and offers alternative auto-buy bids, which can be submitted in place of the original auto-buy bid, and which have a better chance of succeeding.

The screen 400 may include a menu 401, a field 402, a submit button 408, and a cancel button 410. Field 402 may include an indication of a success score for the original auto-buy bid that is submitted by using the screen 300. The term “success score of an auto-buy bid” as used herein refers to an estimate of the probability of the target product of the auto-buy bid selling to the user at or below the target price of the auto-buy bid. For example, and without limitation, the success score of an auto-buy bid may be an estimate of the likelihood that the price of the target product of the auto-buy bid (including available discounts) would become less than or equal to the target price of the auto-buy bid.

The menu 401 may include options 404A, 406A, and 407A. Each of options 404A and 406A corresponds to a different respective auto-buy bid that is associated with the original auto-buy bid. Option 407A corresponds to an instantaneous discount offer. The auto-buy bid submitted via the screen 300 is herein referred to as “the original auto-buy bid”, the auto-buy bid corresponding to option 404A is herein referred to as “the first auto-buy bid”, and the auto-buy bid corresponding to option 406A is herein referred to as “the second auto-buy bid.”

The first auto-buy bid (associated with option 404A) is generated by substituting the target price value of the original auto-buy bid with a new target price value. The first auto-buy bid may constitute an offer to buy the alternative product, which the user has the option to submit instead of the original auto-buy bid. The first auto-buy bid may be provided in the menu 401 in response to the auto-buy manager detecting that the success score for the original auto-buy bid is less than a threshold. Additionally or alternatively, in some implementations, the first auto-buy bid may be provided in the menu 401 if, and only if, the system 105 detects that the success score for the first auto-buy bid is greater than a predetermined threshold and/or greater than the success score of the original auto-buy bid.

The second auto-buy bid (associated with option 406A) is generated by finding an alternative product, which is similarly priced and has similar specifications to the target product of the original auto-buy bid. The alternative product in this example is “MODEL_7 15.6″ laptop” and the target product of the original auto-buy bid is “MODEL_1 13″ laptop”. The second auto-buy bid may constitute an offer to buy the alternative product, which the user has the option to submit instead of the original auto-buy bid. In some implementations, the second auto-buy bid may be provided in the menu 401 if, and only if, the system 105 detects that the success score for the first auto-buy bid is greater than a predetermined threshold and/or if the system 105 detects greater than the success score of the original auto-buy bid.

The instantaneous discount offer (associated with option 407A) is generated by finding an alternative product, and offering the user a discount which brings down the price of the alternative product to the price specified in the original auto-buy bid (or a similar price). Although in the present example the instantaneous discount offer associated with option 407A is a limited-time offer, alternative implementations are possible in which a period for which the offer will remain open is not specified. By selecting option 407A and pressing the button 408, the user may purchase right away the product which is the subject of the instantaneous discount offer.

FIG. 4B is a diagram of the screen 400, according to another example. In the example of FIG. 4B, the screen 400 indicates that the original auto-buy bid (that is specified via the screen 300) has a high likelihood of resulting in a purchase/sale and offers a fallback auto-buy bid, which can be submitted in addition to the original auto-buy bid. In the example of FIG. 4B, the menu 401 includes options 404B and 406B. Option 404B corresponds to a third auto-buy bid and option 406B corresponds to a fourth auto-buy bid. The third auto-buy bid is identical to the original auto-buy bid, but for having a lower target price. The lower target price may be equal to the target price of the original auto-buy bid minus any discounts that the system 105 has found to be available to the user. Showing a lower price in this manner is advantageous because it may increase customer satisfaction by showing the user that the retail website does its best to find the lowest price possible. The fourth auto-buy bid may be identical to the second auto-buy bid that is associated with option 406A (shown in FIG. 4A). The only difference is that the second auto-buy bid is being offered as an alternative to the original auto-buy bid and the fourth auto-buy bid is being offered as a fallback option. Although in the example of FIGS. 4A-B, the menu 401 does not include the original auto-buy bid, alternative implementations are possible in which the original auto-buy bid is also provided in the menu 401. In some implementations, the fourth auto-buy bid may be presented in the menu if, and only if, the success score for the fourth auto-buy bid is greater than a threshold and/or within a predetermined distance from the success score of the original auto-buy bid.

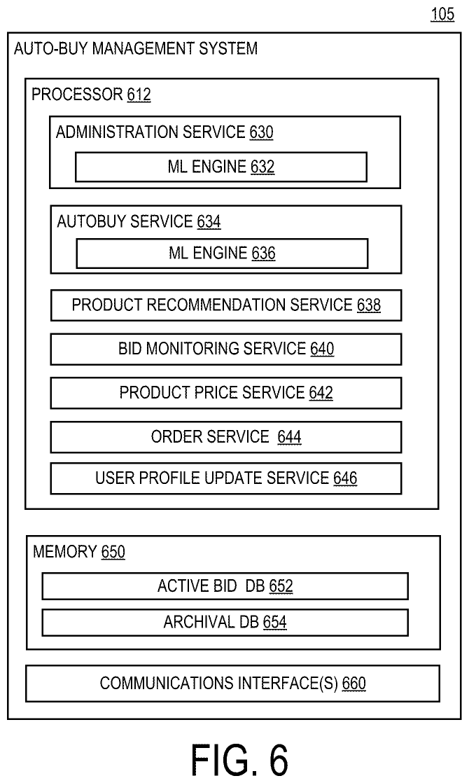

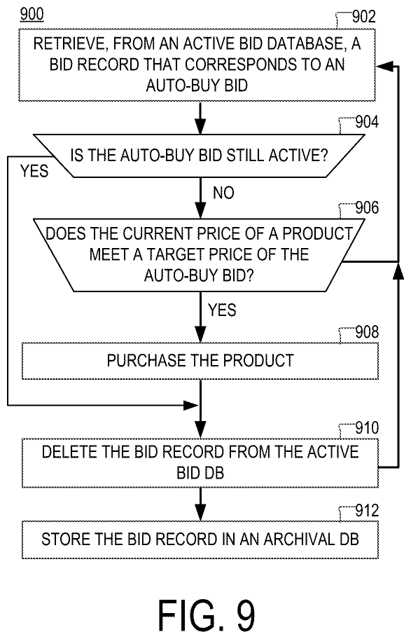

In operation, the user can select one of the auto-buy bids that are presented in the menu 401 and press the submit button 408. Pressing the submit button 408 may cause the given client device 102 (i.e., the client device displaying the screen 400) to transmit an indication of the user's selection to the system 105. In response to receiving the indication, the system 105 may generate a record for the selected auto-buy bid and store the record in the active bid database 652 (shown in FIG. 6). After that, the auto-bid record may be processed in accordance with a process 900, which is discussed further below with respect to FIG. 9.

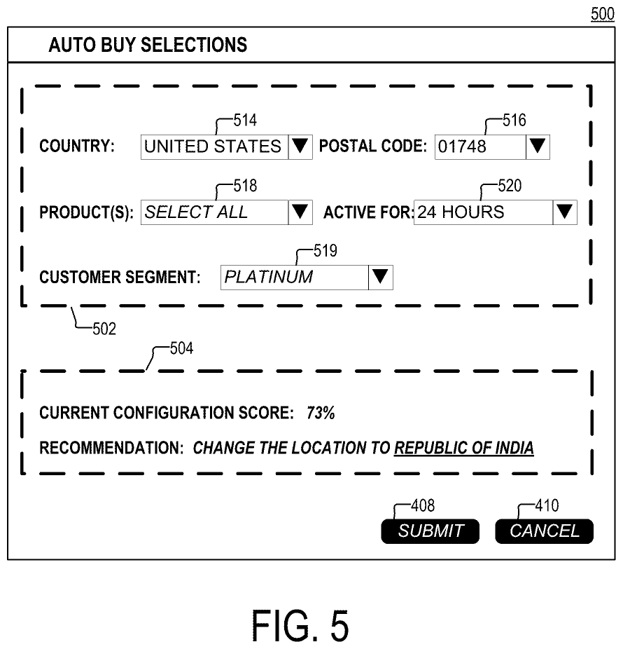

FIG. 5 is a diagram of an example of a screen 500, for specifying an auto-buy campaign, according to aspects of the disclosure. As illustrated, the screen 500 may include a portion 502 and a portion 504. The screen 500 may be rendered on a display device of the system 105 and/or the display of an administrator terminal for the system 105.

Portion 502 may be configured to receive user input specifying the values of one or more parameters of an auto-buy campaign. According to the example of FIG. 5, portion 502 may be configured to specify the location where the auto-buy campaign would be active, products for which the auto-by feature would be enabled during the auto-buy campaign, and the duration of the auto-buy campaign. Portion 502 may include input components 514-520. Input component 514 may be configured to receive user input specifying the country where the auto-buy campaign is going to be active—i.e., the geographic location(s) in which the auto-buy button would be enabled for users who are visiting product webpages for the products associated with the campaign. Input components 516 may be configured to receive user input specifying the postal code of the location that is targeted by the auto-buy campaign. Input component 518 may be configured to receive user input identifying one or more products, for which the auto-buy feature would be enabled as part of the auto-buy campaign. And input component 520 may be configured to receive user input specifying the duration for which the auto-buy feature would be enabled for the products identified with input component 518—i.e., the duration of the auto-buy campaign. Furthermore, in some implementations, portion 502 may include an input component 519 for specifying a user segment for which the campaign would be available. In the present example, the input component 519 specifies that the campaign would be available to “platinum” customers, but not for “silver” or “bronze” customers. Additionally or alternatively, in some implementations, portion 502 may also include an input component for disabling the auto-buy option and/or an input component for disabling the auto-buy recommendation option.

Portion 504 of the screen 500 may be configured to provide feedback on the efficacy of the auto-buy campaign that is specified in portion 502. Specifically, portion 504 may include the value of a configuration score for the campaign that is being specified in portion 502. The configuration score may be an estimate of the auto-buy conversion rate of the auto-buy campaign. As such, the configuration score may indicate the percentage of a total number of auto-buy bids that are submitted as part of the campaign, which would result in a purchase. The total number of auto-buy bids may include a count of only auto-buy bids for products that are targeted by the auto-buy campaign, which are received over the duration of the auto-buy campaign.

Furthermore, portion 504 may be configured to provide a recommendation for improving the efficacy of the auto-buy campaign that is being specified in portion 502. According to the present example, portion 504 indicates that if the location for the auto-buy campaign is changed from the United States of America to the Republic of India, this would result in an increase of configuration score of the auto-buy campaign. In one aspect, presenting the configuration score in the screen 500 is advantageous because it allows administrators of the re-tail website to fine-tune the parameters of auto-buy campaigns, thus increasing their efficacy. In one aspect, presenting the configuration score in the screen 500 is advantageous because it may prevent customer dissatisfaction (or frustration) that would result from participation in “hopeless” auto-buy campaigns in which most auto-buy bids never stood the chance of being fulfilled.

FIG. 6 is a diagram of the system 105, according to aspects of the disclosure. The system 105 may include a processor 612, a memory 650, and a communications interface(s) 660. The processor 612 may include any of one or more general-purpose processors (e.g., ×86 processors, RISC processors, ARM-based processors, etc.), one or more Field Programmable Gate Arrays (FPGAs), one or more application-specific circuits (ASICs), and/or any other suitable type of processing circuitry. The memory 650 may include any suitable type of volatile and/or non-volatile memory. In some implementations, the memory 650 may include one or more of a random-access memory (RAM), a dynamic random memory (DRAM), a flash memory, a hard drive (HD), a solid-state drive (SSD), a network accessible storage (NAS), and or any other suitable type of memory device. The communications interface 660 may include any suitable type of communications interface, such as one or more Ethernet adapters, one or more Wi-Fi adapters (e.g., 802.1414 adapters), and one or more Long-Term Evolution (LTE) adapters, for example.

The processor 612 may be configured to execute an administration service 630, an auto-buy service 634, a product recommendation service 638, a bid monitor service 640, a product price service 642, an order service 644, and a user profile update service 646. The memory 650 may be configured to store an active bid database 652, and an archival database 654.

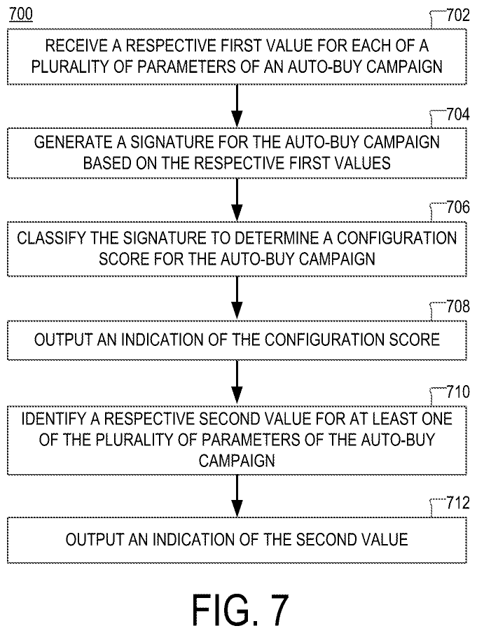

The service 630 may be configured to receive a request to initiate an auto-buy campaign. The request may specify respective first values for one or more campaign parameters. The first values may be received via a user interface, such as the screen 500, which is discussed above with respect to FIG. 5. The service 630 may calculate a respective configuration score for the auto-buy campaign. The service 630 may present the configuration score to the user, via a user interface screen, such as the screen 500. The service 630 may further identify a second value for at least one of the campaign parameters, which if used, would result in an increased configuration score for the campaign. The service 630 may present the second value to the user, via a user interface screen, such as the screen 500. The service 630 may be configured to execute a process 700, which is discussed below with respect to FIG. 7.

The service 630 may be configured to execute a machine learning (ML) engine 632. The ML engine 632 may be configured to execute one or more machine learning models for calculating configuration scores for auto-buy campaigns. The machine learning models may include a linear regression model, a neural network, and/or any other suitable type of machine learning model.

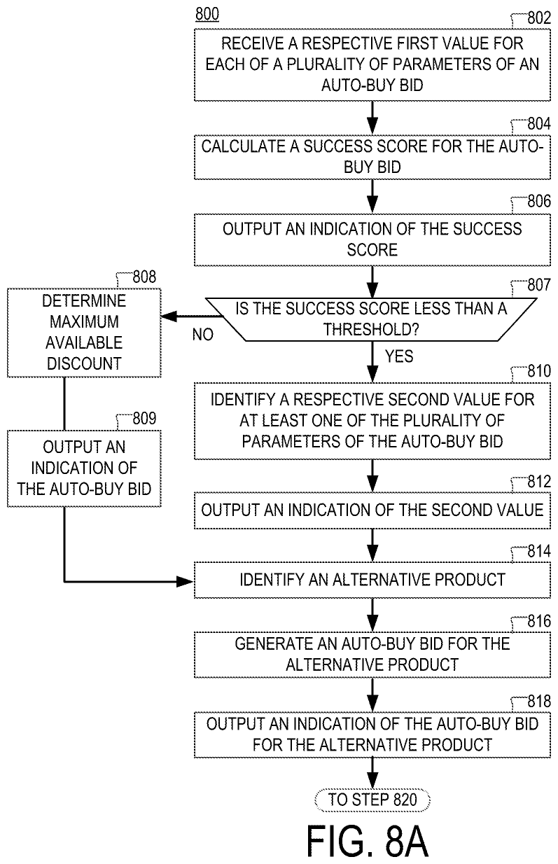

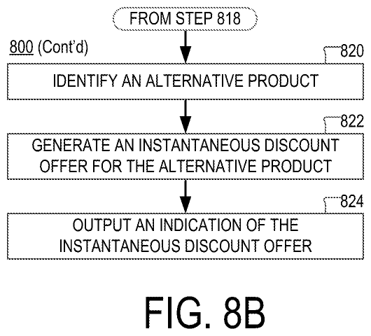

The auto-buy service 634 may be configured to receive a request to create an active auto-buy bid from any of the client devices 102. The requests may be submitted by using the user interface screens that are discussed above with respect to FIGS. 2-4B. The auto-buy service 634 may be configured to: (i) receive a new auto-buy bid for a given product that is specified by the user (e.g., by using the screen 300, shown in FIG. 3), (ii) calculate a configuration score for the auto-buy bid, (iv) identify one or more alternative products, (v) generate alternative auto-buy bids for the alternative products, which have better configuration scores than the auto-buy bid that is provided by the user, and (vi) present an indication of the configuration score of the user-specified auto-buy bid, and/or present the alternative auto-buy bids to the user (e.g., by using the screen 400, shown in FIGS. 4A-B), (v) receive user input indicating that the user would like to finalize a particular auto-buy bid (e.g., detect that the submit button 408 is pressed, shown in FIGS. 4A-B), and (vi) create an active bid record for the particular auto-buy bid (e.g., the particular auto-buy bid may be an auto-buy bid that is selected in the menu 401), and (vii) store the record in the active bid database 652. The auto-buy service 634 may be configured to execute a process 800, which is discussed below with respect to FIG. 8.

The auto-buy service 634 may be configured to execute a machine learning (ML) engine 636. The ML engine 636 may be configured to execute one or more machine learning models for calculating success scores for auto-buy bids. The machine learning models may include a linear regression model, a neural network, and/or any other suitable type of machine learning model.

The product recommendation service 638 may be configured to: (i) receive, from the auto-buy service 634, an indication of a product that is associated with a user-specified auto-buy bid, and (ii) identify one or more similar products that can be used to generate alternative auto-bids, and (iii) provide identifiers corresponding to the similar products to the auto-buy service 634.

The bid monitoring service 640 may be configured to process active bids that are pending in the active bid database 652. The bid monitoring service 640 may be configured to execute a process 900, which is discussed below with respect to FIG. 9.

The product price service 642 may be configured to: (i) detect changes in the price of products that are associated with active auto-buy bids that are pending in the active bid database 652, and (ii) publish the changes to the auto-buy service 634.

The order service 644 may be configured to: (i) receive, from the bid monitoring service 640, an instruction to purchase a product that is associated with an active auto-buy bid, (ii) execute the purchase, and (iii) return to the bid monitoring service 640 a confirmation that the purchase has been completed.

The user profile service 646 may be configured to: (i) receive, from the bid monitoring service 640, an instruction to update a user's profile to indicate that the user has purchased a product that is associated with an active auto-buy bid, (ii) perform the update, and (iii) return to the bid monitoring service 640 a confirmation that the update has been completed.

The active bid database 652 may be configured to store a plurality of records, wherein each record corresponds to an active auto-buy bid. The archival database 654 may be configured to store a plurality of records, wherein each of the records corresponds to an auto-buy bid that has been executed successfully or expired. The contents of the archival database 654 may be used to train the machine learning models used by ML engines 632 and 636.

In some implementations, the system 105 may be configured to fine-tune the models that are implemented by the ML engines 632 and 636 by learning the relationship between auto-bid success scores and/or configuration scores and various parameters, such as: user segment, product, brand, seasonality, trends, weekday-related variations, promotions, price changes, etc. The relationship may be learned and re-learned by using information that becomes available as incoming auto-buy bids are processed. In some implementations, the ML model used by the service 630 to calculate auto-buy campaign configuration scores may be configured to learn mappings between different combinations of campaign parameters, and respective configuration scores.

In some implementations, the ML engine 636 may be configured to execute a machine learning model for calculating a product demand score (hereinafter “product demand model”). The product demand score may be a measure of the demand for a target product during the duration of an auto-buy bid that is associated with the product The product demand model may be configured to calculate a product demand score for a target product (that is associated with an auto-buy bid) based on: demand patterns for the target product (e.g., seasonality, trends that might take place during the life of the auto-buy bid, weekday-related variation in demand that might occur during the life of the auto-buy bid), business decisions that have been made for the target product (e.g., promotions and price changes, etc.), and external factors that might affect demand for the product (e.g., the overlap between holidays and the duration of an auto-buy bid, overlap between the period in which the auto-buy bid will be active and local events, discounts given for the target product by competitors, etc.) In some implementations, the service 634 may be configured to generate a signature for an auto-buy bid, which is indicative of one or more of the above parameters, and classify the signature with product demand model into one of a plurality of categories, wherein each category corresponds to a different product demand score. The product demand model may implement a machine learning algorithm, such as be determined using a machine learning algorithm, such as ordinary least squares, linear least squares, linear regression, logistic regression, polynomial regression, stepwise regression, ridge regression, lasso regression, elastic net regression, or another similar regression algorithm. Furthermore, it will be understood that alternative implementations are possible in which the product demand model is implemented by using a neural network, such as a feed-forward network, etc. The product demand model may be trained using a supervised learning algorithm. The training data set used by the algorithm may include a plurality of training data items. Any of the training data items may include a product demand signature that was generated for an auto-buy bid that was submitted in the past, and a label that identifies the actual product demand that was experienced by the auto-buy bid's target product.

In some implementations, the ML engine 636 may be configured to execute a machine learning model for calculating a price volatility score (hereinafter “price volatility model”). The price volatility score may be an estimate of the expected price volatility of the target product of an auto-buy bid. The price volatility model may be configured to calculate a price volatility score for a target product (that is associated with an auto-buy bid) based on: product name, brand name, product condition, the average price of the product during a past period, whether there is an overlap between the period in which the auto-buy bid is going to be active and other events, such as holidays or festivals, etc. In some implementations, the service 634 may be configured to generate a signature for an auto-buy bid, which is indicative of one or more of the above parameters, and classify the signature with price volatility model into one of a plurality of categories, wherein each category corresponds to a different price volatility score or score range. The price volatility model may implement a machine learning algorithm, such as be determined using a machine learning algorithm, such as ordinary least squares, linear least squares, linear regression, logistic regression, polynomial regression, stepwise regression, ridge regression, lasso regression, elastic net regression, or another similar regression algorithm. Furthermore, it will be understood that alternative implementations are possible in which the price volatility model is implemented by using a neural network, such as a feed-forward network, etc. The price volatility model may be trained using a supervised learning algorithm. The training data set used by the algorithm may include a plurality of training data items. Any of the training data items may include a price volatility signature for an auto-buy bid that was submitted in the past, and a label that identifies the price volatility for the target product of the auto-buy bid.

In some implementations, the ML engine 636 may be configured to execute a machine learning model for calculating a customer score (hereinafter “customer score model”). The customer score model may be configured to calculate a customer score for a customer (who submitted an auto-buy bid) based on: whether the customer is a new customer or an existing customer, the credit score of the customer, the frequency at which the customer conducts transactions on the retail website, the value of the auto-buy bid (i.e., whether the target price of the auto-buy bid is large or the markup associated with the target product is high), historic behavior pattern of the customer, overlap between the period in which the bid is going to be active and other events, such as holidays or festivals, etc. In some implementations, the service 634 may be configured to generate a signature for an auto-buy bid, which is indicative of one or more of the above parameters, and classify the signature with customer score model into one of a plurality of categories, wherein each category corresponds to a different customer score or score range. The customer score model may implement a machine learning algorithm, such as be determined using a machine learning algorithm, such as ordinary least squares, linear least squares, linear regression, logistic regression, polynomial regression, stepwise regression, ridge regression, lasso regression, elastic net regression, or another similar regression algorithm. Furthermore, it will be understood that alternative implementations are possible in which the customer score model is implemented by using a neural network, such as a feed-forward network, etc. The customer score model may be trained using a supervised learning algorithm.

In some implementations, the ML engine 636 may be configured to execute a machine learning model for calculating the success score for an auto-bid (hereinafter “success score model). The success score model may be configured to calculate a success score for an auto-buy bid based on a product demand score for the target product of the auto-bid, an estimated price for the target bid, and the values of one or more parameters of the auto-buy bid. In some implementations, the service 634 may be configured to generate a signature for an auto-buy bid, which is indicative of one or more of the above parameters (e.g., product demand score, estimated price, and auto-bid parameter values), and classify the signature with success score model into one of a plurality of categories, wherein each category corresponds to a different success score or score range. The success score model may implement a machine learning algorithm, such as be determined using a machine learning algorithm, such as ordinary least squares, linear least squares, linear regression, logistic regression, polynomial regression, stepwise regression, ridge regression, lasso regression, elastic net regression, or another similar regression algorithm. However alternative implementations are possible in which the success score model is implemented by using a neural network, such as a feed-forward network, etc. The success score model may be trained using a supervised learning algorithm. Any of the training data items may include price volatility signature for an auto-buy bid that was submitted in the past, and a label that identifies the price volatility for the target product of the auto-buy bid. The training data set used by the algorithm may include a plurality of training data items. Any of the training data items may a customer score signature that is (approximately) shared by a plurality of bids, and a label that indicates the percentage of those bids that ended up being fulfilled.

FIG. 7 is a flowchart of an example of a process 700, according to aspects of the disclosure. In the example of FIG. 7, the process 700 is performed by the service 630. However, the present disclosure is not limited to any specific entity performing the service 630.

At step 702, the service 630 receives a respective first value for each of a plurality of auto-buy campaign parameters. According to the present example, the respective first values for the campaign parameters are specified by using the screen 500 (shown in FIG. 5). According to the present example, the campaign parameters include those that are shown in FIG. 5—e.g., COUNTRY, PRODUCT(S), POSTAL CODE, and DURATION. According to the present example, the first values are the same as the values shown in FIG. 5—e.g., “United States”, “Select All”, “01748”, and “24 Hours”. The respective first values may be received as part of a request to create a new auto-buy campaign. The request may be transmitted by the device displaying the screen 500.

At step 704, a signature is calculated for the campaign based on the first values. The signature may be configured to encode (or indicate) each of the first values. It will be understood that the present disclosure is not limited to any specific format for the signature.

At step 706, the service 630 classifies the signature (generated at step 704) to obtain a configuration score for the campaign. According to the present example, the signature is classified by using the ML engine 632 to evaluate a machine learning model for calculating configuration scores for auto-buy campaign. The machine learning model may implement a machine learning algorithm, such as be determined using a machine learning algorithm, such as ordinary least squares, linear least squares, linear regression, logistic regression, polynomial regression, stepwise regression, ridge regression, lasso regression, elastic net regression, or another similar regression algorithm. Furthermore, it will be understood that alternative implementations are possible in which the configuration score model is implemented by using a neural network, such as a feed-forward network, etc. The configuration score model may be trained using a supervised learning algorithm. The training data set used by the algorithm may include a plurality of training data items. Each of the training data items may include a signature for an auto-buy campaign that was conducted in the past, and a label that identifies the actual conversion rate that was achieved by the campaign.

At step 708, the service 630 outputs an indication of the configuration score. In the example of FIG. 5, the configuration score is equal to “73%”. This configuration score means that 73% of the auto-buy bids received throughout the campaign are expected to result in a purchase. Outputting the indication of the second value may include transmitting the value of the configuration score to the device displaying the screen 500 and/or otherwise causing the value of the configuration score to be displayed in the screen 500.

At step 710, the service 630 identifies a second value for any of the plurality of parameters, which, if selected, would cause the configuration score for the campaign to increase. The second value may be identified by: (i) selecting a configuration parameter, (ii) identifying one or more second values that can be assumed by the configuration parameter, (iii) re-calculating the configuration score for each of the second values, and (iv) and selecting the second value of the configuration parameter that causes the configuration score to improve the most. In the example of FIG. 5, the selected campaign parameter is “COUNTRY”, the first value of the selected campaign parameter is “UNITED STATES” and the selected second value of the campaign parameter is “REPUBLIC OF INDIA”.

At step 712, the service 630 outputs an indication of the second value. Outputting the indication of the second value may include transmitting the second value to the device displaying the screen 500 and/or otherwise causing the indication to be displayed in the screen 500. In the example of FIG. 5, the indication of the second value is output in portion 504, as part of a recommendation for improving the efficacy of the auto-buy campaign.

FIGS. 8A-B show a flowchart of an example of a process 800, according to aspects of the disclosure. In the example of FIG. 8, the process 800 is performed by the service 634. However, the present disclosure is not limited to any specific entity performing the process 800.

At step 802, the service 634 receives a respective first value for each of a plurality of parameters of an auto-buy bid (hereinafter “original auto-buy bid”). According to the present example, the first values are specified by using the screen 300 (shown in FIG. 3), and they are received from a given one of the client devices 102 on which the screen 300 is displayed. According to the present example, the parameters of the original auto-buy bid are the same as those that are shown in FIG. 3—i.e., an identifier of a target product (e.g., MODEL_1 13″ LAPTOP), a target price (e.g., $800), a duration for which the auto-bid is desired to remain open (e.g., 24 HOURS), the town where the target product is desired to be shipped (e.g., HOPKINTON), and the ZIP code of the location where the product is desired to be shipped (e.g., 01748). The first request may be received as part of a request to create an auto-buy bid (hereinafter “original auto-buy bid”) that is received by the system 105.

At step 804, the service 634 calculates a success score for the original auto-buy bid. The success score may be calculated as a function of product demand, predicted price, and user-specified criteria, in accordance with equation 1 below:

S=Λ(w1*B, w2*F, CR) (1)

Where S is the success score, B is a product demand score for the target product, and F is the lowest price that the target product is expected to reach during the period in which the auto-buy bid is desired to remain open. CR may include the target price that of the auto-buy bid received at step 802 (e.g., the price that is input by using the input component 304 of the screen 300). Additionally or alternatively, CR may include the duration of the auto-buy bid, and/or any other of the first values received at step 802. In one implementation, B may evaluate to a discrete value that belongs to the set {1, 2, 3, 4, and 5}, with 5 corresponding to high product demand, and 1 corresponding to low product demand. The value of B may be determined by using the product demand score, which is discussed above with respect to FIG. 6. The function Λ may be evaluated by using the success score model, which is discussed above with respect to FIG. 6. In one implementation, the function Λ may evaluate to a discrete value that belongs to the set {1, 2, 3, 4, and 5}, with ‘1’ corresponding to a low probability of success and ‘5’ corresponding to a high probability of success. In some implementations, the weights w1 and w2 may be calculated by the service 634. In some implementations, each of the weights w1 and w2 may be in the range 0.0-1.0. For example, if the target price CR is greater than the lowest possible price F, weight w2 may be given a smaller value than weight w1. On the other hand, if the target price CR is less than the lowest possible price F, weight w2 may be given a larger value than weight w1. In some respects, the weights w1 and w2 may be used to bias the success score S based on whether the target price CR is expected to be met, thus ensuring that the success score S is going to have a low value when the target price CR cannot be satisfied. The estimated price F may be determined in accordance with Equation 2 below:

F=Cp−D+E (2)

Where Cp is the current manufacturer recommended price (MPR) of the target product, D is the amount of discount the customer is eligible for during a particular interval (% discount), and E is the shipping cost for the associated product. In some implementations, the value of D may be determined in accordance with Equation 3, which is discussed further below. In some implementations, the value of Cp may be determined by using the price volatility model, which is discussed above with respect to FIG. 6.

At step 806, the service 634 outputs an indication of the success score. The indication of the success score may include the value of the success score or an interpretation of the success score. The interpretation of the success score may be determined by using a data structure that maps different success score values to respective interpretations. Such data structure may map a success score value of ‘1 ’ to the interpretation of “Your chances are slim to none.” As another example, the data structure may map a success score value of ‘5’ to the interpretation of “Your chances are excellent.” In some implementations, outputting the indication of the success score may include transmitting the second value to the given client device 102 (i.e., the client device 102 that is displaying the screen 300) and/or causing the success score to be displayed in the screen 400 (shown in FIGS. 4A-B).

At step 807, the service 634 detects if the success score (calculated at step 804) is less than a threshold. If the success score is less than the threshold, the process 800 proceeds to step 810. Otherwise, if the success score is greater than or equal to the threshold, the process 800 proceeds to step 808. According to the present example, the threshold is equal to ‘3’.

At step 808, the service 634 determines the maximum discount which the customer is eligible for. The maximum discount may be determined in accordance with equations 3 and 4 below:

D=CID*v*CSD (3)

CID=Cp−COST−MM (4)

where, CID is customized instant discount, CSD is a customer segment score, COST is the cost of the product to the retail website, and MM is a minimum margin value. The value of CSD may vary depending on a tier of the customer who submitted the auto-buy bid (received at step 802). If the customer is classified in a “platinum” tier, the value of CSD may be 1. On the other hand, if the customer is classified in a “silver” tier, the value of CSD may be 0.7. V is a user-specific weight coefficient. The value of v may be determined using machine learning (ML) and referencing the customer's segment and a customer score CQ for the customer. In some implementations, the customer score CQ may evaluate to a discrete value that belongs to the set {1, 2, 3, 4, and 5}, and it may be based on one or more of: the segment of the customer, the volume of transactions performed by the customer during a predetermined time period (e.g., in the past 3 months). In some implementations, the customer score CQ may be determined based on the customer score model which is discussed above with respect to FIG. 6.

At step 809, the service 634 outputs an indication of the original auto-buy bid. If the target price of the product is greater than the difference between the current price of the product and the discount (determined at step 808) the system may include in the indication of the auto-buy bid, the lower price (i.e., the price after the discount). In some implementations, outputting the indication of the original auto-buy bid may include transmitting the second value to the given client device 102 (i.e., the client device 102 that is displaying the screen 300) and/or causing the indication of the original auto-buy bid to be displayed in the menu 401 of the screen 400 (shown in FIGS. 4A-B).

In the example of FIG. 4B, the indication of the original auto-buy bid is output as option 404B. It will be noted that the target price displayed as part of option 404B is less than the price specified in the screen 300 because the user is eligible for discounts. In some implementations, outputting the indication of the success score may include transmitting the second value to the given client device 102 (i.e., the client device 102 that is displaying the screen 300) and/or causing the success score to be displayed in the screen 400 (shown in FIGS. 4A-B).

At step 810, service 634 identifies a second value for any of the plurality of parameters, which, if selected, would cause the success score for the original auto-bid to increase. The second value may be identified by: (i) selecting a bid parameter, (ii) identifying one or more second values that can be assumed by the bid parameter, (iii) re-calculating the success score based on each of the second values, and (iv) and selecting one of the second values based on the success score for that value. In the example of FIG. 4A, the selected bid parameter is “PRICE”, the first value of the selected campaign parameter is “800” and the selected second value of the campaign parameter is “950”. In some implementations, when the selected bid parameter is “PRICE”, the selected second value may be the smallest one of all second values, which bring the success score to a value that is greater than 75%. Additionally or alternatively, in some implementations, when the selected bid parameter is “PRICE”, the selected second value may be one of the second values, which results in the largest success score. In some implementations, when the selected parameter is price, any available discount may be factored into the second value of the price. In some implementations, the value of the available discount may be determined as discussed above with respect to FIG. 8. Although in the example of FIG. 8 the selected auto-buy bid parameter is price, it will be understood that the present disclosure is not limited to any specific parameter being selected. For example, other parameters that may be selected include “DURATION”, “ZIP CODE” or “TOWN”

At step 812, the service 634 outputs an indication of the original auto-buy bid, which includes the second value of the selected parameter (determined at step 810) instead of the first value for the selected parameter (received at step 802). In some implementations, outputting the indication of the original auto-buy bid may include transmitting the second value to the given client device 102 (i.e., the client device 102 that is displaying the screen 300) and/or causing the indication of the original auto-buy bid to be displayed in the menu 401 of the screen 400 (shown in FIGS. 4A-B). In the example of FIG. 4A, the original auto-buy bid is displayed as option 404A.

Although in the example of FIG. 8, the value of the second parameter is output at step 812. Alternative implementations are possible in which the original auto-bid is output as is followed by a recommendation to change one or more of the parameters of the auto-buy bid, without providing specific values for the parameters.

At step 814, the service 634 identifies an alternative product that is similar to the target product of the original auto-buy bit. The identified product may be one that is similar in price and/or configuration, and it may be identified by using any suitable model for making buying recommendations.

At step 816, the service 634 generates an alternative auto-buy bid, in which the alternative product (identified at step 810) is the target product. The target price of the alternative auto-buy bid may be lower than the current price of the alternative product. In some implementations, the target price may be selected to be sufficiently large so that the success score for the alternative auto-buy bid remains above a predetermined threshold (e.g., 3).

At step 818, the service 634 outputs an indication of the auto-buy bid for the alternative product (generated at step 814). In some implementations, outputting the indication of the alternative auto-buy bid may include transmitting the second value to the given client device 102 (i.e., the client device 102 that is displaying the screen 300) and/or causing the indication of the alternative auto-buy bid to be displayed in the menu 401 of the screen 400 (shown in FIGS. 4A-B). In the example of FIGS. 4A-B, the indication of the alternative auto-buy bid is displayed as options 406A-B. When the threshold of the original auto-buy bid is greater than or equal to the threshold, the indication of the alternative auto-buy bid may be styled as a fallback option, and when the threshold of the original auto-buy bid is less than the threshold, the indication of the alternative auto-buy bid may be presented as an option that has better chances of success than the original auto-buy bid.

At step 820, the service 634 identifies an alternative product that is similar to the target product of the original auto-buy bid. The identified product may be one that is similar in price and/or configuration, and it may be identified by using any suitable model for making buying recommendations. In some implementations, the alternative product may have a higher price than the target price of the auto-buy bid (received at step 802). Additionally or alternatively, in some implementations, the alternative product may be selected such that a discount is available for the alternative product, which would bring the total cost of the alternative product below (or within a predetermined distance from) the target price.

At step 822, the service 634 generates an instantaneous discount offer for the product identified at step 820.

At step 824, the service 634 outputs an indication of the instantaneous discount offer (generated at step 822). In some implementations, outputting the indication of the instantaneous discount offer may include transmitting the second value to the given client device 102 (i.e., the client device 102 that is displaying the screen 300) and/or causing the indication of the alternative auto-buy bid to be displayed in the menu 401 of the screen 400 (shown in FIGS. 4A-B). In the example of FIG. 4A, the indication of the instantaneous discount offer is displayed as options 407A. As noted above, the instantaneous discount offer may be styled as being available for a limited time period only. However, alternative implementations are possible in which no time limit is placed on accepting the instantaneous discount offer.

FIG. 9 is a flowchart of an example of a process 900, according to aspects of the disclosure. In the example of FIG. 9, the process 900 is performed by the bid monitoring service 640. However, it will be understood that the present disclosure is not limited to any specific entity executing the process 900.

At step 902, the service 640 retrieves, from the active bid database 652, a record corresponding to an auto-buy bid. The auto-buy bid, as noted above, may be associated with a target product and a target price that is being offered for the target product.

At step 904, the service 640 detects if the auto-buy bid is still active. If the auto-buy bid is still active, the process 900 proceeds to step 906. Otherwise, if the auto-buy bid has expired, the process 900 proceeds to step 910.

At step 906, the service 640 detects whether the current price of the target product meets the target price. The current price of the target product may be determined by using the product price service 642. The current price of the target product meets the target price when it satisfies a condition that is specified in the auto-bid. In the present example, the condition is satisfied when the current price is less than the target price (see also field 303, shown in FIG. 3). However, the present disclosure is not limited to any specific condition. If the current price of the target product meets the target price, the process 900 proceeds to step 908. Otherwise, the process 900 returns to step 902.

At step 908, the service 640 purchases the target product on behalf of the user who submitted the auto-bid request. Specifically, the service 640 may cause the order service 644 to place an order for the target product, in which: (i) the user who submitted the auto-bid request is the purchaser, (ii) the payment for the purchase is performed using payment information that belongs to the user, and (iii) the delivery address is the address of the user. After the purchase order is executed, the service 640 may cause the user profile update service 646 to add a record of the order to a profile for the user that is maintained on the hosting system 104.

At step 910, the service 640 deletes the bid record from the active bid database 652.

At step 912, the service 640 stored the bid record into the archival database 654. Before storing the bid record into the archival database 654, the service 640 may insert in the bid record an indication of the reason for which the bid record was deleted from the active bid database 652. For example, the indication may indicate that the bid record was deleted from the active bid database 652 because it had expired or because it was fulfilled.

Referring to FIG. 10, computing device 1000 may include processor 1002, volatile memory 1004 (e.g., RAM), non-volatile memory 1006 (e.g., a hard disk drive, a solid-state drive such as a flash drive, a hybrid magnetic and solid-state drive, etc.), graphical user interface (GUI) 1008 (e.g., a touchscreen, a display, and so forth) and input/output (I/O) device 1020 (e.g., a mouse, a keyboard, etc.). Non-volatile memory 1006 stores computer instructions 1012, an operating system 1016 and data 1018 such that, for example, the computer instructions 1012 are executed by the processor 1002 out of volatile memory 1004. Program code may be applied to data entered using an input device of GUI 1008 or received from I/O device 1020.

Processor 1002 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard-coded into the electronic circuit or soft coded by way of instructions held in a memory device. A “processor” may perform the function, operation, or sequence of operations using digital values or using analog signals. In some embodiments, the “processor” can be embodied in an application-specific integrated circuit (ASIC). In some embodiments, the “processor” may be embodied in a microprocessor with associated program memory. In some embodiments, the “processor” may be embodied in a discrete electronic circuit. The “processor” may be analog, digital or mixed-signal. In some embodiments, the “processor” may be one or more physical processors or one or more “virtual” (e.g., remotely located or “cloud”) processors.

FIGS. 1-10 are provided as an example only. At least some of the steps discussed with respect to FIGS. 1-10 can be performed in a different order, in parallel, or altogether omitted. In the example of FIGS. 1-10, each of the product demand scores, success scores and customer scores is a discrete value selected from the set {1, 2, 3, 4, 5}. However, alternative implementations, are possible in which any of these scores is a non-discrete value. Stated succinctly, the present disclosure is not limited to any specific format for any of the scores that are discussed therein.

It will be understood that the campaign parameters discussed thorough the disclosure are provided as an example only. The concepts and ideas, examples of which are described in the disclosure, are not limited to any specific set of campaign parameters, and/or any specific campaign parameter being used. It will be understood that the auto-bid parameters discussed thorough the disclosure are provided as an example only. The concepts and ideas, examples of which are described in the disclosure, are not limited to any specific set of auto-bid parameters, and/or any specific auto-bid parameter being used.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method for use in a hosting system of a retail website, comprising:
receiving respective first values for a plurality of parameters of an auto-buy campaign, the respective first values being specified by an administrator of the retail website hosting system;
calculating a configuration score for the auto-buy campaign based on the respective first values for the plurality of parameters of the auto-buy campaign, the configuration score being indicative of a percentage of auto-buy bids submitted as part of the auto-buy campaign that are expected to result in a purchase; and
outputting an indication of the configuration score for presentation to the administrator.

2. The method of claim 1, further comprising causing the hosting system to provide at least one of an auto-buy option and an instant discount option in accordance with the respective first values for the plurality of parameters of the auto-buy campaign.

3. The method of claim 1, further comprising:
identifying a second value for a given one of the plurality of parameters of the auto-buy campaign, which, if substituted for the respective first value of the given parameter of the auto-buy campaign, would increase a value of the configuration score for the auto-buy campaign; and
outputting an indication of the second value for presentation to a user.

4. The method of claim 1, wherein the plurality of parameters includes one or more of geographic location, customer segment, duration, and product range.

5. The method of claim 1, further comprising:
receiving respective first values for a plurality of parameters of a first auto-buy bid, the plurality of parameters of the first auto-buy bid including a product identifier corresponding to a first product and an indication of a first target price for the first product, the respective first values being specified by a user of the retail website;
calculating a success score for the first auto-buy bid, the success score being indicative of a likelihood of the first product selling to the user at or below the first target price; and
outputting an indication of the success score for presentation to the user.

6. The method of claim 5, further comprising:
identifying an alternative value for at least one of the plurality of parameters of the first auto-buy bid, which, if substituted for the respective first value of a given one of the plurality of parameters of the first auto-buy bid, would increase a value of the success score for the first auto-buy bid; and
outputting an indication of the alternative value for presentation to the user.

7. The method of claim 5, further comprising:
generating a second auto-buy bid for a second product, the second auto-buy bid being associated with a second target price for the second product, the second target price being lower than a current price of the second product; and
outputting an indication of second the auto-buy bid for presentation to the user, thereby giving the user an option to select the second auto-buy bid instead of the first auto-buy bid.

8. A method for use in a hosting system of a retail website, comprising:
receiving respective first values for a plurality of parameters of a first auto-buy bid, the plurality of parameters of the first auto-buy bid including a product identifier corresponding to a first product and an indication of a first target price for the first product, the respective first values being specified by a user of the retail website;
calculating a success score for the first auto-buy bid, the success score being indicative of a likelihood of the first product selling to the user at or below the first target price; and
outputting an indication of the success score for presentation to the user.

9. The method of claim 8, further comprising:
identifying an alternative value for at least one of the plurality of parameters of the first auto-buy bid, which, if substituted for the respective first value of a given one of the plurality of parameters of the first auto-buy bid, would increase a value of the success score for the first auto-buy bid; and
outputting an indication of the alternative value for presentation to the user.

10. The method of claim 9, further comprising:
generating a second auto-buy bid for a second product, the second auto-buy bid being associated with a second target price for the second product, the second target price being lower than a current price of the second product; and
outputting an indication of second the auto-buy bid for presentation to the user, thereby giving the user an option to select the second auto-buy bid instead of the first auto-buy bid.

11. The method of claim 8, further comprising:
receiving respective first values for a plurality of parameters of an auto-buy campaign, the respective first values being specified by an administrator of the retail website hosting system;
calculating a configuration score for the auto-buy campaign based on the respective first values for the plurality of parameters of the auto-buy campaign, the configuration score being indicative of a percentage of auto-buy bids submitted as part of the auto-buy campaign that are expected to result in a purchase; and
outputting an indication of the configuration score for presentation to the administrator.

12. The method of claim 11, further comprising causing the hosting system to provide an auto-buy option in accordance with the respective first values for the plurality of parameters of the auto-buy campaign.

13. The method of claim 11, further comprising:
identifying a second value for a given one of the plurality of parameters of the auto-buy campaign, which, if substituted for the respective first value of the given parameter of the auto-buy campaign, would increase a value of the configuration score for the auto-buy campaign; and
outputting an indication of the second value for presentation to a user.

14. The method of claim 11, wherein the plurality of parameters includes one or more of geographic location, customer segment, duration, and product range.

15. A system comprising:
a memory; and
one or more processors operatively coupled to the memory, the one or more processors being configured to perform the operations of:
receiving respective first values for a plurality of parameters of a first auto-buy bid, the plurality of parameters of the first auto-buy bid including a product identifier corresponding to a first product and an indication of a first target price for the first product, the respective first values being specified by a user of a retail website;
calculating a success score for the first auto-buy bid, the success score being indicative of a likelihood of the first product selling to the user at or below the first target price; and
outputting an indication of the success score for presentation to the user.

16. The system of claim 15, wherein the at least one processor is further configured to perform the operations of:
identifying an alternative value for at least one of the plurality of parameters of the first auto-buy bid, which, if substituted for the respective first value of a given one of the plurality of parameters of the first auto-buy bid, would increase a value of the success score for the first auto-buy bid; and
outputting an indication of the alternative value for presentation to the user.

17. The system of claim 15, wherein the at least one processor is further configured to perform the operations of:
generating a second auto-buy bid for a second product, the second auto-buy bid being associated with a second target price for the second product, the second target price being lower than a current price of the second product; and
outputting an indication of second the auto-buy bid for presentation to the user, thereby giving the user an option to select the second auto-buy bid instead of the first auto-buy bid.

18. The system of claim 15, wherein the at least one processor is further configured to perform the operations of:
receiving respective first values for a plurality of parameters of an auto-buy campaign, the respective first values being specified by an administrator of a hosting system of the retail website;
calculating a configuration score for the auto-buy campaign based on the respective first values for the plurality of parameters of the auto-buy campaign, the configuration score being indicative of a percentage of auto-buy bids submitted as part of the auto-buy campaign that are expected to result in a purchase; and
outputting an indication of the configuration score for presentation to the administrator.

19. The system of claim 18, wherein the at least one processor is further configured to perform the operation of causing a hosting system of the retail website to provide an auto-buy option in accordance with the respective first values for the plurality of parameters of the auto-buy campaign. 20 The system of claim 18, wherein the at least one processor is further configured to perform the operations of:
identifying a second value for a given one of the plurality of parameters of the auto-buy campaign, which, if substituted for the respective first value of the given parameter of the auto-buy campaign, would increase a value of the configuration score for the auto-buy campaign; and
outputting an indication of the second value for presentation to a user.
